(19) United States
(12) Patent Application Publication
(10) Pub. No.: US 2015/0070296 A1
(43) Pub. Date: Mar. 12, 2015

(54) TOUCH PANEL AND METHOD OF USING THE SAME

(71) Applicant: HENGHAO TECHNOLOGY CO., LTD., Taoyuan County (TW)

(72) Inventor: Ming-Shan KUO, Taoyuan County (TW)

(73) Assignee: HENGHAO TECHNOLOGY CO., LTD., Taoyuan County (TW)

(21) Appl. No.: 14/098,593

(22) Filed: Dec. 6, 2013

(30) Foreign Application Priority Data
Sep. 9, 2013 (TW) 102132498

(51) Int. Cl. G06F 3/044

(52) U.S. Cl. CPC G06F 3/044
USPC 345/174

(57) ABSTRACT

A method for using a touch panel is disclosed. The method includes the steps of providing the touch panel having a circuit, and performing at least one of wirelessly transmitting a first signal from the touch panel to an outer object and wirelessly receiving a second signal transmitted from the outer object to the touch panel by the circuit in a first condition.

### CROSS-REFERENCE TO RELATED APPLICATION AND CLAIM OF PRIORITY

This application claims the benefit of the Taiwan Patent Application No. 102132498, filed on Sep. 9, 2013, in the Taiwan Intellectual Property Office, the disclosures of which are incorporated herein in their entirety by reference.

### FIELD OF THE INVENTION

The present invention relates to a panel. In particular, the present invention relates to a touch panel capable of performing one of transmitting and receiving a signal wirelessly.

### BACKGROUND OF THE INVENTION

The touch panels widely used today, both a resistive and capacitive touch panels receive a signal caused by a finger or a touch panel on the touch panel and translate the signal into coordinates accordingly by some calculation to achieve a desired operational function.

Because touch panels are a human-machine interface and are easily operated, they are widely applied to all kinds of mobile devices such as mobile phones, pad computers and notebook computers. However, touch panels are naturally deemed as merely an interface operated between humans and machines.

To give the touch panel a new operational function and increase convenience for consumers in their daily lives, the idea and the application of the present invention is provided. When the battery power of a mobile phone is low or when there is no suitable medium at hand when you are in a hurry to transmit photos or data to other people for example, the present invention provides a timely solution when a user faces this situation. Therefore, it is necessary to provide a simple way to solve the problem.

### SUMMARY OF THE INVENTION

In accordance with an aspect of the present invention, a method for using a touch panel is disclosed. The method includes steps of providing the touch panel having a circuit, and performing at least one of wirelessly transmitting a first signal from the touch panel to an outer object and wirelessly receiving a second signal transmitted from the outer object to the touch panel by the circuit in a first condition.

Furthermore, the method for using the touch panel further includes steps of providing a processor electrically connected to the circuit, controlling a wireless transmission of the first signal when the first signal is wirelessly transmitted by the processor; and controlling a wireless reception of the second signal when the second signal is wirelessly received by the processor.

Furthermore, the outer object is one selected from a group consisting of a receiver, a transmitter and a combination thereof.

Furthermore, the outer object is a portable apparatus.

Furthermore, the portable apparatus is one of a touch pen and a USB flash disk.

Furthermore, the method for using the touch panel further includes a step of providing a processor electrically connected to the circuit, wherein the touch panel is a projective capacitive touch panel and consists of a substrate and the circuit disposed on the substrate, the circuit is an antenna and the processor processes a variation of capacitance sensed by the circuit.

Furthermore, each of the first signal and the second signal includes one selected from the group consisting of an energy, a datum and a combination thereof, and the energy is one of a radiation and an electric energy.

Furthermore, the method for using the touch panel further includes steps of sensing a position coordinate by the circuit to acquire a third signal generated by the circuit in a second condition, and providing a memory and a battery, both of which are connected to the circuit, to store the first signal it is being wirelessly transmitted.

In accordance with another aspect of the present invention, a touch panel assembly is provided. The touch panel assembly includes a panel body having an antenna, and a processor electrically connected to the antenna and controlling the antenna to perform at least one of transmitting a first signal from the antenna to an external object and receiving a second signal transmitted from the external object to the antenna in a first condition.

Furthermore, the antenna wirelessly transmits the first signal when transmitting the first signal and wirelessly receives the second signal when receiving the second signal.

Furthermore, the first signal includes one selected from a group consisting of a first energy, a first datum and a combination thereof, the second signal includes one selected from a group consisting of a second energy, a second datum and a combination thereof, the touch panel assembly further comprises a battery electrically connected to the processor and a memory electrically connected to the processor, when the first signal includes a first energy, the battery stores the first energy, when the first signal includes the first datum, the memory stores the first datum, when the second signal includes the second energy, the battery stores the second energy, and when the second signal includes the second datum, the memory stores the second datum.

Furthermore, the processor generates a touch signal to respond to an external force exerted on the panel body in a second condition.

Furthermore, the external force is one of a contact force and a distant force.

Furthermore, the external object is a portable apparatus, the antenna is a circuit, the panel body consists of a substrate and the circuit disposed on the substrate, and the panel body is a projective capacitive touch panel.

Furthermore, the portable apparatus is one of a touch pen and a USB flash disk.

In accordance with a further aspect of the present invention, a method for transmitting/receiving a signal is provided. The method for transmitting/receiving a signal includes providing a touch panel having a circuit, providing an external object, and performing at least one of transmitting a first wireless signal from the touch panel to the external object and receiving a second wireless signal transmitted from the external object to the touch panel by the circuit.

Furthermore, the method for transmitting/receiving a signal further includes steps of sensing a variation of capacitance of the circuit, providing a processor electrically connected to the circuit and processing the variation of the capacitance, controlling a transmission of the first wireless signal by the processor when the first wireless signal is transmitted, and controlling a reception of the second wireless signal by the processor when the second wireless signal is received.

Furthermore, the first wireless signal includes one selected from a group consisting of a first energy, a first datum and a combination thereof, the second wireless signal includes one selected from a group consisting of a second energy, a second datum and a combination thereof, and each of the first energy and the second energy is one of a radiation and an electric energy.

Furthermore, the method for transmitting/receiving a signal further includes steps of providing a battery electrically connected to the circuit to store at least one of the first energy when the first wireless signal includes the first energy and the second energy when the second wireless signal includes the second energy, and providing a memory electrically connected to the circuit to store at least one of the first datum when the first wireless signal includes the first datum and the second datum when the second wireless signal includes the second datum.

Furthermore, the external object is one selected from a group consisting of a transmitter, a receiver and a combination thereof, the touch panel is a projective capacitive touch panel and consists of a substrate and the circuit disposed on the substrate, and the circuit is an antenna.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 is a diagram showing a touch panel assembly according to an embodiment of the present invention;

FIG. 2 is a diagram showing the cross-section of a touch panel according to an embodiment of the present invention;

FIGS. 3A, 3B, 3C, 3D, 3E, 3F and 3G are diagrams showing cross-sections of touch panels according to other embodiments of the present invention;

FIGS. 4A and 4B are diagrams showing circuits of a touch panel according to other embodiments of the present invention;

FIGS. 5A and 5B are diagrams showing signals of a touch panel according to other embodiments of the present invention; and

FIGS. 6A, 6B and 6C are diagrams showing cross-sections of touch panels and touch pens according to other embodiments of the present invention;

### DETAILED DESCRIPTION OF THE PREFERRED EMBODIMENT

The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

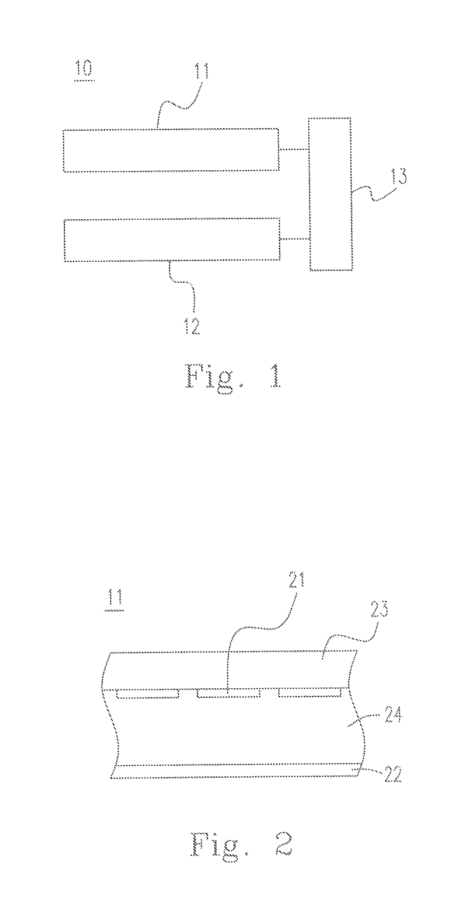

As shown in FIG. 1, the touch panel assembly widely applied to a mobile phone, a pad computer, an instrument, or a piece of equipment, includes a touch panel 11, called a panel body, a display panel 12, and a processor 13. When a coordinate position on the surface of the touch panel 11 receives an external force exerted by either one of, for example, a contact force exerted by an outer object or a distant force applied by another outer object having an electric charge, the touch panel 11 detects the position and the processor 13 decodes position coordinates detected by the touch panel 11. The position coordinates generally include both in x and y directions. An operational function represented by the position coordinate corresponding to the display panel 12, for example, switches one page to another one, and is executed accordingly. In one embodiment of the present invention, the outer object could be one selected from a group consisting of a finger, a touch pen, and a combination thereof.

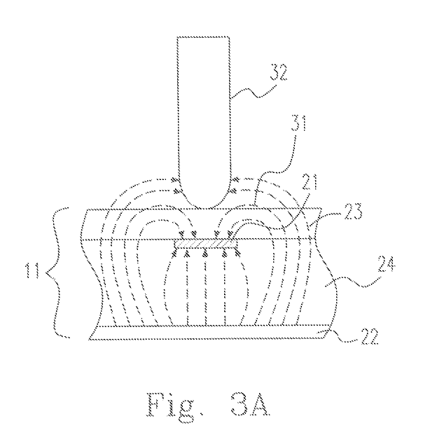

Referring to FIG. 2, the present invention utilizes a circuit disposed on a touch panel, for example, a projective capacitive touch panel. The projective capacitive touch panel senses a variation of capacitance of the circuit, and the processor 13 electrically connected to the circuit processes the variation of the capacitance. The circuit generally includes a first circuit and a second circuit. The first circuit is commonly called an x-direction circuit or a column trace 21, while the second circuit is commonly called a y-direction circuit or a row trace 22. The touch panel 11 has the column trace 21 and the row trace 22 and can generate and transmit a first signal, or a touch signal, to the processor 13 to proceed with a detection function when the touch panel 11 acts as an input apparatus, but it can also be a novel output apparatus to transmit a second signal wirelessly to a receiver. In another embodiment of the present invention, the receiver can be a portable apparatus. For example, the touch panel 11 provides functions that an ordinary touch panel has in a first condition and proceeds with other functions to the outer object in a second condition. The present invention takes advantage of a time-sharing method to separate a full time period spent for inputting and detecting the position coordinates into a first period and a second period. The first period is used for transmitting the first signal while the second period is used for transmitting the second signal from the touch panel 11 to the outer object or further receiving a third signal from the outer object to the touch panel 11. The first period and the second period are combined in series and alternatively rotate so that the functions in the first period and second period are periodically repeated. Therefore, the touch panel 11 is able to provide a new application for outputting and inputting wireless signals without sacrificing its original touch functions. For example, in the first condition previously mentioned, or in the first period, the touch panel 11 having the column trace 21 and the row trace 22 can detect the position coordinates that the external force exerts on the touch panel 11 and translate the position coordinates into the first signal, or the touch signal. The first signal is received and processed by the processor 13. Furthermore, in the second condition, or the second period, at least one of the column trace 21 and the row trace 22 acts as an antenna to transmit the second signal generated by the processor 13 from the touch panel 11 through at least one of the column trace 21 and the row trace 22 to the outer object, or otherwise at least one of the column trace 21 and the row trace 22 acts as a receiving apparatus to receive the third signal from the outer object through either the column trace 21 or the row trace 22.

The full time period mentioned above can also be separated into a first period, a second period and a third period. In the second period, at least one of the column trace 21 and the row trace 22 acts as an antenna to transmit the second signal generated by the processor 13 from the touch panel 11 through either the column trace 21 or the row trace 22 to the outer object. In the third period, either the column trace 21 or the row trace 22 acts as a receiving apparatus to receive the third signal from the outer object.

The second signal can be one selected from a group consisting of an energy or a datum. The energy is one of a radiation and an electric energy, and the datum includes one of an electronic file and a datum file. In one of the practical applications of the present invention, the second signal can be designed according to a desired function of the portable apparatus. For example, when the portable apparatus is a mobile phone, if it is unlucky that the battery power of the mobile phone is low, a user could use the touch panel 11 under the control of the processor 13 of the present invention to wirelessly transmit the second signal to charge the mobile phone in a wireless way. For another example, when the portable apparatus is a USB flash disk, if it is needed to backup a document file or a datum file to another person, people can use the touch panel 11 under the control of the processor 13 of the present invention to wirelessly transmit the second signal to the USB flash disk for copying the document file or the datum file in a wireless way. Of course, it is also feasible for the touch panel 11 to wirelessly receive the third signal having another document file or another datum file from the USB flash disk. For a further example, when the portable apparatus consists of two individual touch pens, a user can use the touch panel 11 under the control of the processor 13 of the present invention to wirelessly transmit the second signal to individually assign a different identification number (ID number) to each of the touch pens in a wireless way. Accordingly, it is possible to read and identify the third signal having an order wirelessly received from at least one of the two touch panes of the touch panel 11 at same time or at different times.

FIG. 2 is a diagram showing a cross-section of a touch panel 11 according to an embodiment of the present invention. The touch panel 11 includes a lengthwise column trace 21 and a transverse row trace 22. The column trace 21 and the row trace 22 are formed on a substrate 23. According to one embodiment of the present invention, the column trace 21 and the row trace 22 can be made of a transparent conductive material, for example, one of an indium tin oxide (ITO), a graphene, an aluminum doped zinc oxide (Al-doped ZnO or AZO), a zinc oxide (ZnO), an antimony doped tin oxide (ATO), a gallium doped zinc oxide (Ga-doped ZnO or GZO), a fluorine doped tin oxide (F-doped SnO₂ or FTO) and a combination thereof, or can be a non-transparent conductive material, for example, a nano silver wire or a metal mesh. The substrate 22 can be one of a glass substrate and a plastic substrate. There is an insulation layer 24 disposed between the column trace 21 and the row trace 22 to prevent the column trace 21 and the row trace 22 from forming an electrical connection.

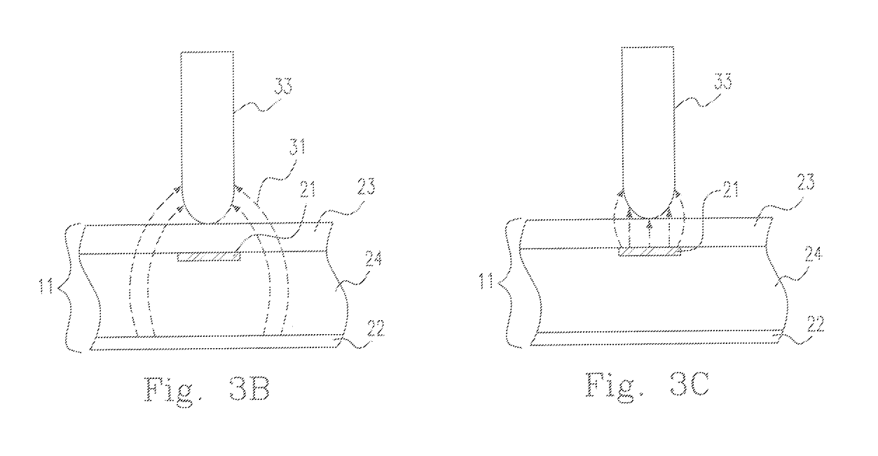

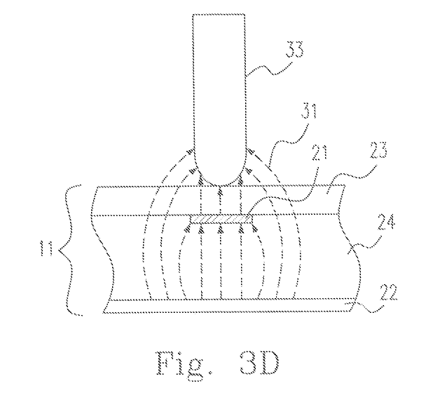

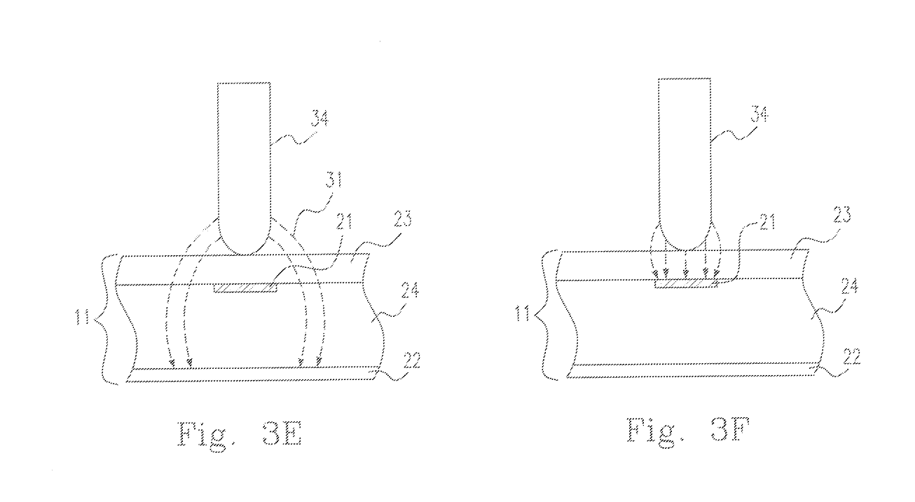

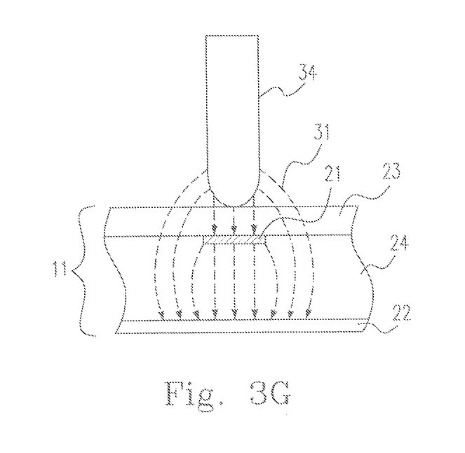

Take a projective capacitive touch panel as an example. In the first period, the touch panel 11 acts as a signal receiving apparatus. Electric lines of an electric field between the column trace 21 and the row trace 22 are distributed as shown in FIG. 3A where the column trace 21 and the row trace 22 are disposed on a surface of the substrate 23, the insulation layer 24 is disposed between the column trace 21 and the row trace 22. When an outer object 32 applies an external force to a position on the surface of the touch panel 11, the electric lines 31 will be interrupted and will influence the sensing energy on the column trace 21. In the second condition, the touch panel 11 acts as a signal transmitting apparatus for transmitting a second signal to an outer object. The electric lines 31 are presently transmitting outwardly from the row trace 22 as shown in FIG. 3B, transmitting outwardly from the column trace 21 as shown in FIG. 3C, or transmitting outwardly from both of the row trace 22 and the column trace 21 as shown in FIG. 3D, to a receiver 33. In the third period, the touch panel 11 acts as a signal inputting apparatus for receiving a third signal transmitted from a transmitter 34, and the electric lines 31 are received by the row trace 22 as shown in FIG. 3E, received by the column trace 21 as shown in FIG. 3F, or received together by the row trace 22 and the column trace 21 as shown in FIG. 3G.

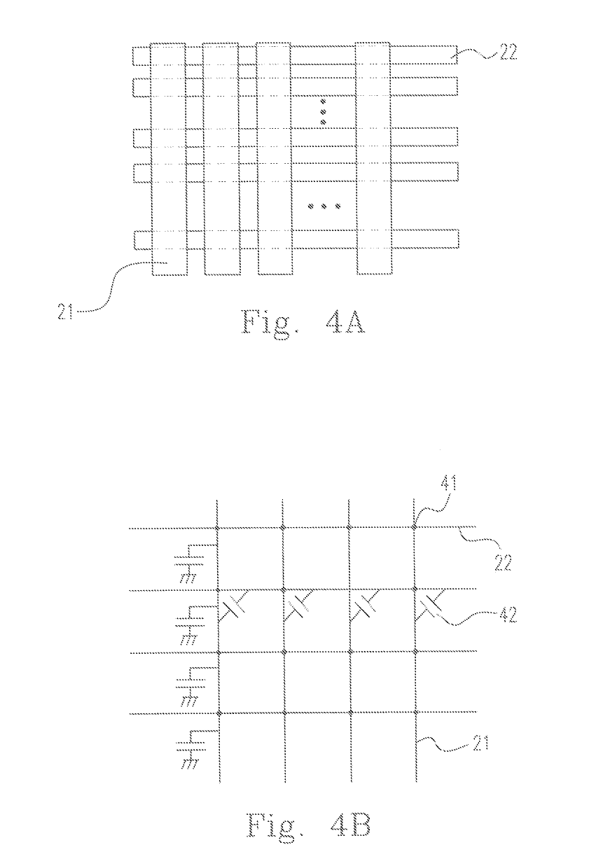

FIG. 4A is a diagram showing a circuit of a touch panel according to another embodiment of the present invention. When the touch panel 11 is a projective capacitive touch panel, its equivalent circuit is schematically shown in FIG. 4B. Each of the intersection points of the column trace 21 and the row trace 22 is a sensing pixel 41 on the touch panel 11. Each sensing pixel 41 forms a capacitor device 42. In addition, each of the column trace 21 and the row trace 22 is electrically connected to the processor 13. Take a resistive touch panel as an example, when the touch panel 11 executes its original functions as a touch panel, when the outer object 32, a finger or a touch pen, touches a position on the surface of the touch panel 11, the variation of the resistivity on each of the column trace 21 and the row trace 22 is received by the processor 13 and the processor 13 judges the position coordinates accordingly. As another example, take a projective capacitive touch panel, when the outer object 32, a finger or a touch pen, touches a position on the surface of the touch panel 11, the variation of the capacitance on each of the column trace 21 and the row trace 22 is received by the processor 13 and the processor 13 judges the position coordinates accordingly. The shape and the allocation of the column trace 21 and the row trace 22 can be designed according to the requirements of the resistive touch panel or the projective capacitive touch panel.

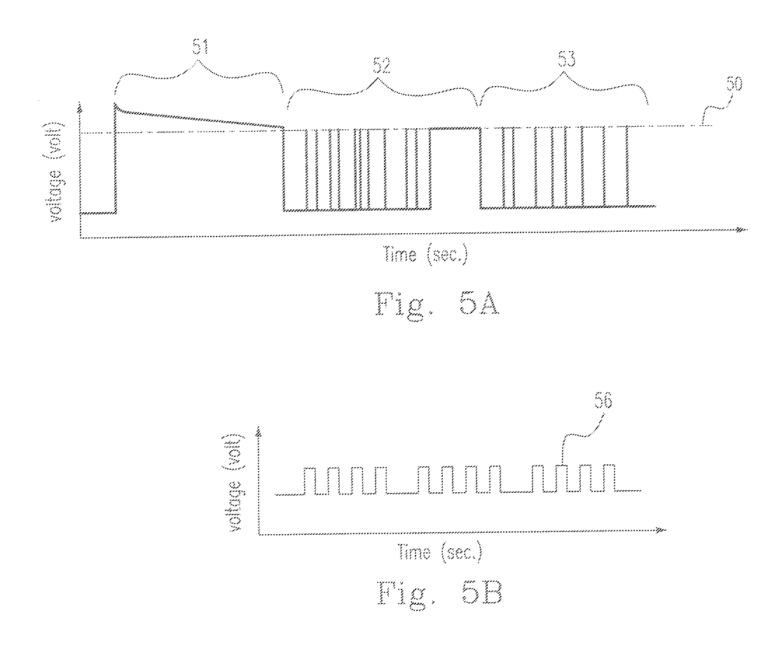

As another example, take another projective capacitive touch panel as shown in FIG. 5A. The dashed line represents a reference voltage 50. For example, in the first period of a first full time period, there is no external force sensed by the touch panel 11, the processor 13 sends out a first signal 51, and the voltage difference between the column trace 21 and the row trace 22 is a little bit higher than the reference voltage 50. After that, in the second period of the first full time period, the processor 13 generates a second signal 52 transmitted either the column trace 21 or the row trace 22 to an outer object 32. After that, in the third period of the first full time period, the processor 13 receives a third signal 53 transmitted from the outer object 32 by way of the column trace 21, the row trace 22 or the combination of the column trace 21 and the row trace 22.

According to another embodiment of the present invention, if the touch panel 11 is not needed for a touch operation, the first period can be removed so that the touch panel 11 only performs the function in the second period, that is, the processor 13 generates the second signal 52 wirelessly transmitting to the outer object 32 through the column trace 21, the row trace 22 or the combination thereof, or the processor 13 receives the third signal 53 wirelessly transmitted from the outer object 32 through the column trace 21, the row trace 22 or the combination thereof.

The second signal 52 and the third signal 53 should be designed according to the types of the signal to be transmitted. For example, either the second signal 52 or the third signal 53 can be designed as the signal 56 shown in FIG. 5B.

According to another embodiment of the present invention, a third circuit (not shown in the figures) replacing the first circuit and a fourth circuit (not shown in the figures) replacing the second circuit for wireless transmitting/receiving the second or third signal can be additionally disposed in a non-effective area where there is no circuit disposed on the touch panel 11. The cross-section diagram of either the third circuit or the fourth circuit is the same as shown in FIG. 2. In a practical application, the first circuit and the second circuit used in the first period are different from the third circuit and the fourth circuit used in the second period.

According to another embodiment of the present invention, the time separation for the first period, the second period and the third period in any full time period can be designed as required. For example, the first period should be sufficient to meet the time required to complete the touch functions. In addition, a fourth period and even a fifth period can be designed in the same full time period depending one actual functions required for using the touch panel 11.

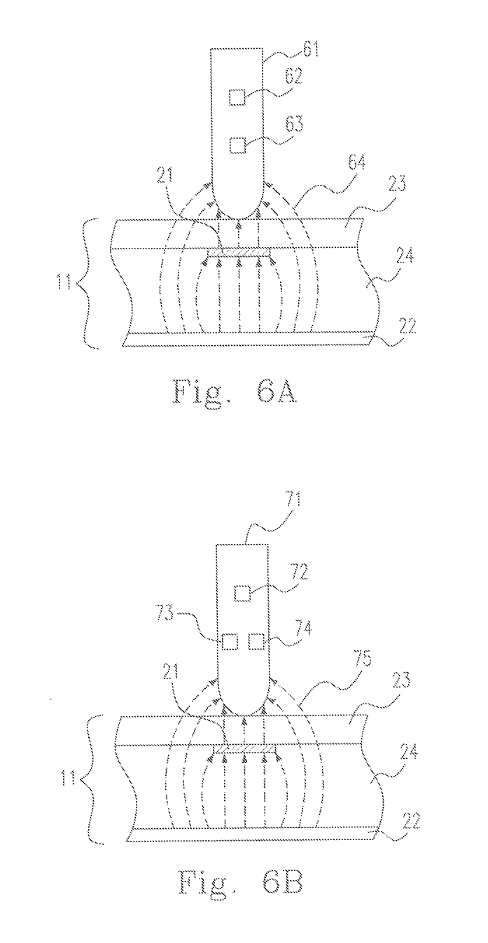

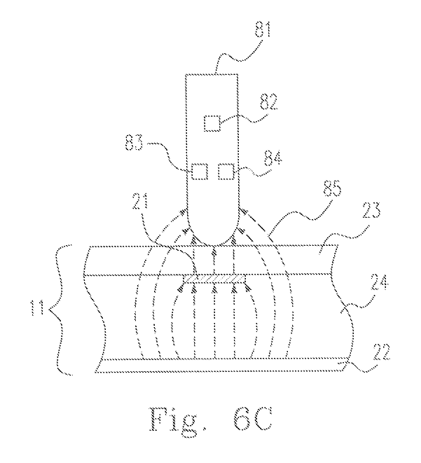

FIG. 6A is a diagram showing a cross-section of a touch panel 11 and a touch pen 61 according to another embodiment of the present invention. The touch panel 11 is used to charge the outer object 32 such as a touch pen 61. The touch pen 61 includes a power module 62 and a driving circuit 63. When the power of the power module is low, the driving circuit 63 senses the electric lines 64 of an electric field formed on the column trace 21 and the row trace 22 of the touch panel 11 by a battery or a power supply (not shown in FIG. 6A) electrically connected to the column trace 21 and the row trace 22, and the electric energy possessed by the electric field is transferred into the electric energy which will be consecutively stored in the power module 62, thereby charging the touch pen 61. According to another embodiment of the present invention, the power charging can be operated in the reverse direction, i.e., from the outer object 62 such as the touch pen 61 to the battery of the touch panel 11 as well.

FIG. 6B is a diagram showing a cross-section of a touch panel 11 and a touch pen 71 according to another embodiment of the present invention. The touch pen 71 includes a power module 72, a driving circuit 73 and a communication storage block 74. In a practical application, the touch pen 71 receives a frequency pulse generated on the column trace 21 and the row trace 22. The frequency pulse includes an identification number exclusively assigned to the touch pen 71. The identification number is stored in the communication storage block 74 for the processor 13 to identify the touch pen 71. When the touch panel 11 is in the first period, the touch pen 71 exerts an external force to a position on the surface of the touch panel 11 so that the processor 13 can obtain not only the position coordinates but also the identification number of the touch pen 71 transmitted through the touch panel 11. Consequently, the processor 13 can identify the position coordinates when it is touched and external force is exerted by the touch pen 71. The function and the advantage provided by the present invention will be more significant and meaningful when two different touch pens are used at the same time.

FIG. 6C is a diagram showing a cross-section of a touch panel 11 and a touch pen 81 according to another embodiment of the present invention. The touch pen 81 includes a power module 82, a driving circuit 83 and a memory device 84. The touch panel 11 has a memory (not shown in FIG. 6C) electrically connected to the column trace 21 and the row trace 22. The application principle of this embodiment is same as the one described in the previous paragraph. The difference is that a signal via the electric lines 85 wirelessly transmitted from the touch panel 11 is a datum signal. The datum signal can be transferred and stored in the memory device 84 of the touch pen 81 so that the purpose of datum copying to the touch pen 81 is fulfilled. This embodiment can also be applied to a USB flash disk to fulfill the same purpose. According to another embodiment of the present invention, the datum copying can operate in a reverse direction, i.e., from the touch pen 81 to the memory of the touch panel 11 as well.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for using a touch panel, comprising steps of:
providing the touch panel having a circuit; and
performing at least one of wirelessly transmitting a first signal from the touch panel to an outer object and wirelessly receiving a second signal transmitted from the outer object to the touch panel by the circuit in a first condition.

2. A method for using the touch panel according to claim 1, further comprising steps of:
providing a processor electrically connected to the circuit;
controlling a wireless transmission of the first signal when the first signal is wirelessly transmitted by the processor; and
controlling a wireless reception of the second signal when the second signal is wirelessly received by the processor.

3. A method for using the touch panel according to claim 1, wherein the outer object is one selected from a group consisting of a receiver, a transmitter and a combination thereof.

4. A method for using the touch panel according to claim 1, wherein the outer object is a portable apparatus.

5. A method for using a touch panel according to claim 4, wherein the portable apparatus is one of a touch pen and a USB flash disk.

6. A method for using the touch panel according to claim 1, further comprising a step of:
providing a processor electrically connected to the circuit, wherein the touch panel is a projective capacitive touch panel and consists of a substrate and the circuit disposed on the substrate, the circuit is an antenna and the processor processes a variation of a capacitance sensed by the circuit.

7. A method for using the touch panel according to claim 1, wherein each of the first signal and the second signal includes one selected from a group consisting of an energy, a datum and a combination thereof, and the energy is one of a radiation and an electric energy.

8. A method for using the touch panel according to claim 1, further comprising steps of:
sensing a position coordinate by the circuit to acquire a third signal generated by the circuit in a second condition; and
providing a memory and a battery, both of which are connected to the circuit, to store the first signal before being wirelessly transmitted.

9. A touch panel assembly, comprising:
a panel body having an antenna; and
a processor electrically connected to the antenna and controlling the antenna to perform at least one of transmitting a first signal from the antenna to an external object and receiving a second signal transmitted from the external object to the antenna in a first condition.

10. A touch panel assembly according to claim 9, wherein the antenna wirelessly transmits the first signal when transmitting the first signal and wirelessly receives the second signal when receiving the second signal.

11. A touch panel assembly according to claim 9, wherein the first signal includes one selected from a group consisting of a first energy, a first datum and a combination thereof, the second signal includes one selected from a group consisting of a second energy, a second datum and a combination thereof, the touch panel assembly further comprises a battery electrically connected to the processor and a memory electrically connected to the processor, when the first signal includes a first energy, the battery stores the first energy, when the first signal includes the first datum, the memory stores the first datum, when the second signal includes the second energy, the battery stores the second energy, and when the second signal includes the second datum, the memory stores the second datum.

12. A touch panel assembly according to claim 9, wherein the processor generates a touch signal to respond to an external force exerted on the panel body in a second condition.

13. A touch panel assembly according to claim 12, wherein the external force is one of a contact force and a distant force.

14. A touch panel assembly according to claim 9, wherein the external object is a portable apparatus, the antenna is a circuit, the panel body consists of a substrate and the circuit disposed on the substrate, and the touch panel body is a projective capacitive touch panel.

15. A touch panel assembly according to claim 14, wherein the portable apparatus is one of a touch pen and a USB flash disk.

16. A method for transmitting/receiving a signal, comprising steps of:
providing a touch panel having a circuit;
providing an external object; and
performing at least one of transmitting a first wireless signal from the touch panel to the external object and receiving a second wireless signal transmitted from the external object to the touch panel by the circuit.

17. A method for transmitting/receiving the signal according to claim 16, comprising steps of:
sensing a variation of capacitance of the circuit;
providing a processor electrically connected to the circuit and processing the variation of the capacitance;
controlling a transmission of the first wireless signal by the processor when the first wireless signal is transmitted; and
controlling a reception of the second wireless signal by the processor when the second wireless signal is received.

18. A method for transmitting/receiving the signal according to claim 16, wherein the first wireless signal includes one selected from a group consisting of a first energy, a first datum and a combination thereof, the second wireless signal includes one selected from a group consisting of a second energy, a second datum and a combination thereof, and each of the first energy and the second energy is one of a radiation and an electric energy.

19. A method for transmitting/receiving the signal according to claim 18, further comprising steps of:
providing a battery electrically connected to the circuit to store at least one of the first energy when the first wireless signal includes the first energy and the second energy when the second wireless signal includes the second energy; and
providing a memory electrically connected to the circuit to store at least one of the first datum when the first wireless signal includes the first datum and the second datum when the second wireless signal includes the second datum.

20. A method for transmitting/receiving the signal according to claim 16, wherein the external object is one selected from a group consisting of a transmitter, a receiver and a combination thereof, the touch panel is a projective capacitive touch panel and consists of a substrate and the circuit disposed on the substrate, and the circuit is an antenna.
